(19) United States
(12) Patent Application Publication
(10) Pub. No.: US 2026/0193405 A1
(43) Pub. Date: Jul. 9, 2026

(54) POLYISOCYANATE MIXTURE

(71) Applicant: Covestro Deutschland AG, Leverkusen (DE)

(72) Inventor: Hans-Josef Laas, Odenthal (DE)

(21) Appl. No.: 19/130,575

(22) PCT Filed: Nov. 27, 2023
(86) PCT No.: PCT/EP2023/083099

§ 371 Date: May 16, 2025

(30) Foreign Application Priority Data
Nov. 29, 2022 (EP) 22210094.3
Aug. 18, 2023 (EP) 23192136.2
Aug. 18, 2023 (EP) 23192137.0

(51) Int. Cl. C08G 18/78; C08G 18/28; C09D 175/04

(52) U.S. Cl. CPC C08G 18/7837; C08G 18/2835; C09D 175/04

(57) ABSTRACT

The invention relates to a polyisocyanate mixture, a process for its production and its use as starting component in the production of polyurethane plastics. The invention further relates to coating agents containing the polyisocyanate mixture and to the substrates coated with said coating agents.

The present invention relates to a polyisocyanate mixture and to a process for production thereof. The invention further relates to a use of the polyisocyanate mixture, to a coating composition containing the polyisocyanate mixture and to substrates coated with the coating composition.

Two-component polyurethane coatings (2K-PUR) have become important for numerous different applications on account of their exceptional technological properties. The employed crosslinker components for light-resistant, non-yellowing 2K-PUR coatings are generally polyisocyanates based on linear-aliphatic or cycloaliphatic diisocyanates.

Polyisocyanates based on 1,6-diisocyanatohexane (also referred to as HDI below) are today employed in the majority of applications of 2K-PUR coatings. Even at low temperatures these result in elastic coatings with good resistance towards chemical and mechanical stress.

The trend towards more sustainable products has in recent years also led to increasing demand for biobased raw materials in the field of polyurethanes. This was the reason for the development of polyisocyanate crosslinkers based on 1,5-diisocyanatopentane (hereinafter also referred to as PDI) which is derivable from biomass (see for example EP-A 3 271 432 and WO 2016/169810). PUR coatings and adhesives produced using biobased PDI polyisocyanates have a similar level of properties to those crosslinked with comparable petrochemical-based HDI polyisocyanates and are even superior to these in some applications.

However, a severe disadvantage of PDI polyisocyanates is that compared to corresponding HDI derivatives they exhibit higher viscosities at comparable oligomer distribution (M. Widemann et al., ACS Sustainable Chem. Eng. 2018, 6, 9753-9759; DOI: http://dx.doi.org/10.1021/acssuschemeng.8b00758) and processing thereof generally requires larger amounts of organic solvents. However, especially in sustainable coatings and adhesive systems a lowest possible proportion of volatile organic constituents is desired.

US 2012/0016073 describes a process for producing low-viscosity allophanate polyisocyanates on the basis of monoalcohols containing ether or polyether groups which may be used as reactive diluents for relatively high viscosity polyisocyanates. It generally recites polymethylene diisocyanates having 2 to 6 methylene units as suitable starting diisocyanates for this process and HDI as a preferred starting diisocyanate. Production of the HDI allophanate polyisocyanates necessitate a complex catalyst system consisting of bismuth compounds, preferably bismuth triscarboxylates, and alkali metal and alkaline earth metal salts as cocatalysts. However, bismuth catalysts have the general disadvantage that during prolonged storage and especially on exposure to daylight they undergo decomposition which commonly results in a brown discoloration or even precipitation of black particles in the polyisocyanate (D. Guhl, FAPU 49, 30-33 (2008), DOI: 10-1386-08-EPJ-2-2008-d.indd).

In Polymers 2021, 13, 1255 (DOI: https://doi.org/10.3390/polym13081255) Caillol et al. describe a commercially available product Tolonate™ X FLO 100 from Vencorex produced according to US 2012/0016073 as a partially biobased polyisocyanate having an allophanate structure based on HDI and ethoxylated palmitic acid as a synthesis component for thermoset polyurethanes. The aforementioned disadvantages apply to the production of this product.

Furthermore, in the case of HDI allophanates even small residual amounts of urethane structures which may still be present due to incomplete allophanatization lead to turbidity in the product.

The prior art also provides no pointers to the possible use of PDI for producing corresponding allophanates.

There therefore remained a need to provide low-viscosity allophanate polyisocyanates which remain completely clear and free from turbidity irrespective of the employed catalyst and irrespective of the residual urethane content, even during prolonged storage.

It is an object of the present invention to provide low-viscosity allophanate polyisocyanates which remain completely clear and free of turbidity irrespective of the employed catalyst and irrespective of the residual urethane content, even during prolonged storage.

Taking account of this requirement, the present invention provides a polyisocyanate mixture containing at least one polyisocyanate of general formula (I)

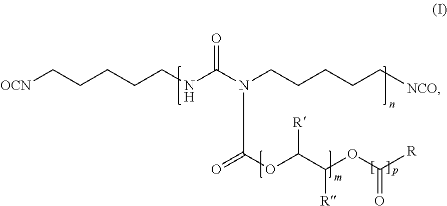

in which
R represents a linear or branched, saturated or unsaturated aliphatic and/or saturated or unsaturated cycloaliphatic radical having (6 to 22)-p carbon atoms which may optionally be substituted,
R′ and R″ independently represent hydrogen or an aliphatic radical having 1 to 10 carbon atoms, wherein at least one of the radicals R′ and R″ represents hydrogen,
n is an integer from 1 to 12,
m is an integer from 1 to 10 and
p is 0 or 1.

The invention also provides a process for producing the polyisocyanate mixtures according to the invention by reacting
A) a diisocyanate component containing at least 1,5-diisocyanatopentane with
B) at least one alcohol of general formula (II)

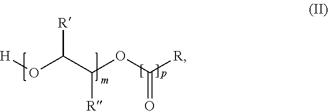

in which
R represents a linear or branched, saturated or unsaturated aliphatic and/or saturated or unsaturated cycloaliphatic radical having (6 to 22)-p carbon atoms which may in each case optionally be substituted,
R′ and R″ independently represent hydrogen or an aliphatic radical having 1 to 10 carbon atoms, wherein at least one of the radicals R′ and R″ represents hydrogen,
m is an integer from 1 to 10 and
p is 0 or 1.

It has now been found that, surprisingly, PDI may be very easily converted into low-viscosity, light-colored allophanate polyisocyanates with ethoxylated fatty alcohols and/or fatty acids even using known allophanation catalysts, such as for example zinc or zirconium catalysts. A particular advantage of the use of PDI is the fact that compared to analogously produced HDI derivatives PDI allophanate polyisocyanates have markedly greater crystallization stability even when incompletely allophanatized and the PDI polyisocyanates according to the invention remain completely clear and free from turbidity even at relatively high residual urethane content.

According to the invention the terms “comprising”, “containing”, are preferably to be understood as meaning “consisting essentially of” and particularly preferably “consisting of”. The further embodiments recited in the claims and in the description may be combined as desired, provided that the context does not clearly indicate the opposite.

“At least one”, as used herein, refers to 1 or more, for example 2, 3, 4, 5, 6, 7, 8, 9 or more. In connection with constituents of the compounds described herein, this figure refers not to the absolute number of molecules, but rather to the nature of the constituent. “At least one polyisocyanate” is therefore to be understood as meaning for example that only one type of polyisocyanate or two or more different types of polyisocyanates may be present without specifying the amount of the individual compounds.

In the present case the polyisocyanate mixture according to the invention containing at least one polyisocyanate of general formula (I) is to be understood as meaning that it generally may contain and preferably contains not only compounds of general formula (I) where n=1 but also one or more compounds of formula (I) where n=2 to 12 which have preferably been formed from PDI and alcohols of general formula (II) and typically further oligomers based on PDI, for example PDI isocyanurates.

It is particularly preferable when the polyisocyanate mixture according to the invention contains more than 60 mol %, preferably more than 65 mol %, particularly preferably more than 70 mol %, yet more preferably more than 75 mol %, of proportions of allophanate structures determinable by NMR spectroscopy based on the total amount of the molar proportions of allophanate, isocyanurate, urethane and uretdione structures.

Numerical values specified herein without decimal places refer in each case to the full value specified to one decimal place. Thus for example “99%” represents “99.0%”.

Numerical ranges given in the format “in/from x to y” include the values stated. If two or more preferred numerical ranges are given in this format, it is understood that all ranges arising from the combination of the various limits are likewise encompassed.

The term “aliphatic” is presently defined as meaning non-aromatic hydrocarbon groups that are saturated or unsaturated.

The term “araliphatic” is presently defined as meaning aliphatic hydrocarbon radicals which are saturated or unsaturated and which have at least one aromatic substituent.

The term “alicyclic” or “cycloaliphatic” is presently defined as meaning optionally substituted carbocyclic or heterocyclic compounds or units which are not aromatic (for example cycloalkanes, cycloalkenes or oxa-, thia-, aza- or thiazacycloalkanes). Particular examples are cyclohexyl groups, cyclopentyl groups and their N- or O-heterocyclic derivatives such as for example pyrimidine, pyrazine, tetrahydropyran or tetrahydrofuran.

In the event that the groups or compounds are disclosed as “optionally substituted” or “substituted” suitable substituents are —F, —Cl, —Br, —I, —OH, —OCH₃, —OCH₂CH₃, —O-isopropyl or —O-n-propyl, —OCF₃, —CF₃, —S—C₁₋₆-alkyl and/or (optionally via a pendant heteroatom) a linear or branched aliphatic and/or alicyclic structural unit having 1 to 12 carbon atoms which in each case functions as a substitute for a carbon-bonded hydrogen atom of the respective molecule. Preferred substituents are halogen (especially —F, —Cl), C₁₋₆ alkoxy (especially methoxy and ethoxy), hydroxyl, trifluoromethyl and trifluoromethoxy which in each case function as a substitute for a carbon-bonded hydrogen atom of the respective molecule.

In a first preferred embodiment the polyisocyanate mixture according to the invention has an NCO content of 6.0% to 18.0% by weight, preferably 8.0% to 16.0% by weight, particularly preferably 10.0% to 15.0% by weight, based on the total weight of the polyisocyanate mixture and/or a residual monomer content measured by gas chromatography using an internal standard according to DIN EN ISO 10283:2007-11 of less than 0.14% by weight, preferably less than 0.12% by weight and particularly preferably less than 0.10% by weight based on the total weight of the polyisocyanate mixture.

In a further preferred embodiment the polyisocyanate mixture according to the invention has a viscosity measured according to DIN EN ISO 3219:1994-10 at a shear rate of 250 s⁻¹ at 23° C. of less than 500 mPas, preferably less than 400 mPas and particularly preferably less than 300 mPas.

Preference is given to a general formula (I),

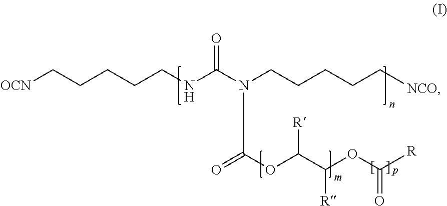

in which
R represents a linear or branched, saturated or unsaturated aliphatic and/or saturated or unsaturated cycloaliphatic radical having (8 to 20)-p, particularly preferably having (10 to 18)-p and very particularly preferably having (12 to 14)-p carbon atoms which may optionally be substituted,
R′ and R″ independently represent hydrogen or an aliphatic radical having 1 to 10 carbon atoms, wherein at least one of the radicals R′ and R″ represents hydrogen,
n is an integer from 1 to 12,
m is an integer from 1 to 7, particularly preferably an integer from 2 to 5 and very particularly preferably an integer from 2 to 4 and
p is 0 or 1.

The diisocyanate component A) used for producing the polyisocyanate mixtures according to the invention contains at least 1,5-diisocyanatopentane (presently also referred to as pentamethylene diisocyanate or PDI) which is obtainable by various routes, for example by phosgenation in the liquid or gas phase or by a phosgene-free route, for example by thermal urethane cleavage proceeding from 1,5-diaminopentane preferably obtained by biotechnological means by decarboxylation of the naturally occurring amino acid lysine.

Optionally co-usable in the diisocyanate component A) in addition to 1,5-diisocyanatopentane are further diisocyanates having aliphatically, cycloaliphatically, araliphatically and/or aromatically bonded isocyanate groups which are likewise obtainable by phosgenation or by a phosgene-free route. These are especially those in the molecular weight range of 140 to 400, for example 1,4-diisocyanatobutane, 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 2,4- and 2,6-diisocyanato-1-methylcyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 2,4′-diisocyanatodicyclohexylmethane, 1-isocyanato-1-methyl-4(3)isocyanatomethylcyclohexane, bis(isocyanatomethyl)norbornane, 1,3- and 1,4-bis(isocyanatomethyl)benzene (XDI), 1,3- and 1,4-bis(2-isocyanatoprop-2-yl)benzene (TMXDI), 2,4- and 2,6-diisocyanatotoluene (TDI), 2,4′- and 4,4′-diisocyanatodiphenylmethane (MDI), 1,5-diisocyanatonaphthalene or any desired mixtures of such diisocyanates.

These diisocyanates for optional co-use in the diisocyanate component A) during production of the polyisocyanate mixtures according to the invention are employed, if at all, in amounts of up to 40% by weight, preferably up to 30% by weight, particularly preferably up to 20% by weight and very particularly preferably up to 10% by weight based on the total amount of diisocyanates employed.

In a further preferred embodiment the diisocyanate component A) employs at least 60% by weight, preferably at least 70% by weight, particularly preferably at least 80% by weight and very particularly preferably at least 90% by weight based on the diisocyanate component A) of 1,5-pentamethylene diisocyanate and optionally further diisocyanates having aliphatically, cycloaliphatically, araliphatically and/or aromatically bonded isocyanate groups in an amount of up to 40% by weight, preferably up to 30% by weight, particularly preferably up to 20% by weight and very particularly preferably up to 10% by weight based on the diisocyanate component A).

A further preferred embodiment relates to a process for producing a polyisocyanate mixture, preferably the polyisocyanate mixture according to the invention, by reacting
A) at least 1,5-diisocyanatopentane with
B) at least one alcohol of general formula (II)

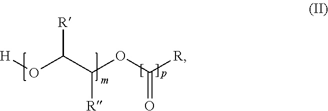

in which
R represents a linear or branched, saturated or unsaturated aliphatic and/or saturated or unsaturated cycloaliphatic radical having (6 to 22)-p carbon atoms which may in each case optionally be substituted,
R′ and R″ independently represent hydrogen or an aliphatic radical having 1 to 10 carbon atoms, wherein at least one of the radicals R′ and R″ represents hydrogen,
m is an integer from 1 to 10 and
p is 0 or 1.

The alcoholic component B) employed in the process according to the invention is at least one alcohol of general formula (II)

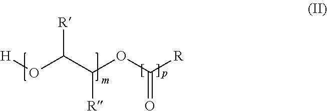

in which
R represents a linear or branched, saturated or unsaturated aliphatic and/or saturated or unsaturated cycloaliphatic radical having (6 to 22)-p, preferably (8 to 20)-p, particularly preferably having (10 to 18)-p and very particularly preferably having (12 to 14)-p carbon atoms which may in each case optionally be substituted,
R′ and R″ independently represent hydrogen or an aliphatic radical having 1 to 10 carbon atoms, wherein at least one of the radicals R′ and R″ represents hydrogen, and
m is an integer from 1 to 10, preferably an integer from 1 to 7, particularly preferably an integer from 2 to 5 and very particularly preferably an integer from 2 to 4 and
p is 0 or 1.

These alcohols are, for example, the known alkoxylation products of fatty alcohols of general formula (111)

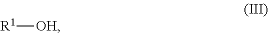

in which
R¹ represents a linear or branched, saturated or unsaturated aliphatic and/or saturated or unsaturated cycloaliphatic radical having 6 to 22, preferably 8 to 20, particularly preferably 10 to 18, very particularly preferably 12 to 14, carbon atoms which may in each case optionally be substituted,
and/or fatty acids of general formula (IV)

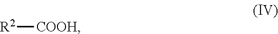

in which
R² represents a linear or branched, saturated or unsaturated aliphatic and/or saturated or unsaturated cycloaliphatic radical having 5 to 21, preferably 7 to 19, particularly preferably having 9 to 17, very particularly preferably 11 to 13, carbon atoms which may in each case optionally be substituted.

For the aforementioned fatty alcohols of general formula (III) it is the case that in general formula (I) and general formula (II) p is 0 and R¹ represents R including the aforementioned preferences for R¹. Radicals R¹ and R that are suitable by way of example, preferred and particularly preferred include the radicals derived from the fatty alcohols recited below as suitable by way of example, preferred and particularly preferred.

For the aforementioned fatty alcohols of general formula (IV) it is the case that in general formula (I) and general formula (II) p is 1 and R² represents R, including the aforementioned preferences for R². Radicals R² and R that are suitable by way of example, preferred and particularly preferred include the radicals derived from the fatty acids recited below as suitable by way of example, preferred and particularly preferred.

Fatty alcohols suitable forthe alkoxylation include, for example, 1-hexanol (caproic alcohol), 1-heptanol (enanthic alcohol), 1-octanol (caprylic alcohol), 1-nonyl alcohol (pelargonic alcohol), 1-decanol (capric alcohol), 1-dodecanol (lauryl alcohol), 1-tetradecanol (myristyl alcohol), 1-hexadecanol (cetyl alcohol), 1-heptadecanol (margaryl alcohol), 1-octadecanol (stearyl alcohol), 1-eicosanol (arachidyl alcohol), 1-docosanol (behenyl alcohol), 1-tetracosanol (lignoceryl alcohol), 1-hexacosanol (ceryl alcohol), 1-octacosanol (montanyl alcohol), 1-triacontanol (melissyl alcohol), cis-9-hexadecen-1-ol (palmitoleyl alcohol), cis-9-octadecen-1-ol (oleyl alcohol), trans-9-octadecen-1-ol (elaidyl alcohol), cis-11-octadecen-1-ol, cis,cis-9,12-octadecadien-1-ol (linoleyl alcohol) and 6,9,12-octadecatrien-1-ol (γ-linolenyl alcohol) and suitable fatty acids include for example hexanoic acid (caproic acid), heptanoic acid (enanthic acid), octanoic acid (caprylic acid), nonanoic acid (pelargonic acid), decanoic acid (capric acid), undecanoic acid, dodecanoic acid (lauric acid), tridecanoic acid, tetradecanoic acid (myristic acid), pentadecanoic acid, hexadecanoic acid (palmitic acid), heptadecanoic acid (margaric acid), octadecanoic acid (stearic acid), nonadecanoic acid, eicosanoic/icosanoic acid (arachinic acid), heneicosanoic acid and docosanoic acid (behenic acid), cis-9-octadecenoic acid (oleic acid) and cis-13-docosenoic acid (erucic acid).

Fatty alcohols and fatty acids produced using vegetable and animal oils and fats are preferred.

Particularly preferred fatty alcohols for producing the alcoholic component B) include 1-decanol, 1-dodecanol, 1-tetradecanol and 1-octadecanol, very particularly preferably 1-dodecanol and 1-tetradecanol, and particularly preferred fatty acids include decanoic acid, dodecanoic acid, tetradecanoic acid and hexadecanoic acid, very preferably dodecanoic acid, tetradecanoic acid. Compounds suitable for production of the alcoholic component B) by alkoxylation of the recited fatty alcohols and/or fatty acids include any desired alkylene oxides having 2 to 12 carbon atoms, for example ethylene oxide, propylene oxide, 1,2-epoxybutane, 1,2-epoxyhexane, 1,2-epoxyoctane or 1,2-epoxydodecane, which are employed in the alkoxylation reaction in any desired sequence or else in admixture.

Preferred alkylene oxides are those having 2 to 4 carbon atoms. Particularly preferred alkylene oxides for producing the alcoholic component B) are ethylene oxide and propylene oxide.

The number of carbon atoms of the radicals R′ or R″ in general formula (I) derives from the alkylene oxides recited above by way of example and as preferable. Accordingly, R′ and R″ in general formula (I) and/or formula (II) independently represent hydrogen or an aliphatic radical having preferably 1 to 2 carbon atoms, wherein at least one of the radicals R′ and R″ represents hydrogen.

Suitable alcoholic components B) for producing the polyisocyanate mixtures according to the invention especially include alkoxylation products of the recited fatty acids and/or fatty alcohols which on average have 1 to 10, preferably 1 to 7, particularly preferably 2 to 5 and very particularly preferably 2 to 4 alkylene oxide units. The inventive and preferred integers m in general formula (I) and general formula (II) derive from the numbers and number ranges recited above as averages.

In a further preferred embodiment the alcoholic component B) is selected from alkoxylation products which on average have 1 to 10, preferably 1 to 7, particularly preferably 2 to 5 and very particularly preferably 2 to 4 alkylene oxide units, wherein the alkylene oxide units preferably comprise or consist of ethylene oxide and/or propylene oxide units. The inventive and preferred integers m in general formula (I) and general formula (II) derive from the numbers and number ranges recited above as averages.

The alcoholic components B) preferably have a pH measured in a 1% solution of the respective alcoholic component B) in water of 4.0 to 8.0, preferably of 4.5 to 7.5, particularly preferably of 5.0 to 7.0 and/or total contents of alkali metal cations of at most 100 ppm, preferably of 1 to 70 ppm, particularly preferably of 2 to 50 ppm.

In addition to the recited alkoxylation products of fatty alcohols and/or fatty acids component B) may optionally contain further alcoholic compounds in a subordinate amount.

These are, for example, monoalcohols, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclohexane, 3-methyl-3-hydroxymethyloxetane, benzyl alcohol, phenol, the isomeric cresols, octylphenols, nonylphenols and naphthols, furfuryl alcohol and tetrahydrofurfuryl alcohol, unbranched aliphatic diols, such as 1,2-ethanediol, 1,3-propanediol, 1,4-butanediol, 1,5-pentanediol, 1,6-hexanediol, 1,7-heptanediol and 1,8-octanediol, cycloaliphatic diols, such as 1,2- and 1,4-cyclohexanediol, 1,4-cyclohexanedimethanol, 4,4′-(1-methylidene)biscyclohexanol, triols such as 1,2,3-propanetriol, 1,1,1-trimethylolethane, 1,2,6-hexanediol, 1,1,1-trimethylolpropane, and 1,3,5-tris(2-hydroxyethyl)isocyanurate, tetrafunctional alcohols, such as 2,2-bis(hydroxymethyl)-1,3-propanediol or any mixtures of such alcohols.

If at all, the process according to the invention employs these further alcoholic compounds in amounts of at most 25% by weight, preferably at most 20% by weight, particularly preferably at most 15% by weight, based on the employed amount of alkoxylation products of fatty alcohols and/or fatty acids.

Performing the process according to the invention comprises reacting the diisocyanate component A) containing at least 1,5-diisocyanatopentane with at least one alcoholic component B) preferably at temperatures of 40° C. to 200° C., particularly preferably of 60° C. to 180° C., and/or while maintaining an equivalent ratio of isocyanate groups to isocyanate-reactive groups of preferably 4:1 to 50:1, particularly preferably of 5:1 to 30:1, very particularly preferably of 10:1 to 25:1, to afford allophanate polyisocyanates.

The process of the invention can be carried out without catalysis, as a thermally induced allophanatization. Preference is however given to using suitable catalysts to accelerate the allophanatization reaction. These are customary known allophanatization catalysts, for example metal carboxylates, metal chelates or tertiary amines of the type described in GB-A-0 994 890 (page 2, lines 73 to 87), alkylating agents of the type described in US-A-3 769 318 (column 6, lines 5 to 49) or strong acids such as are described by way of example in EP-A-0 000 194 (page 13, line 27 to page 14, lines 1 to 18).

Suitable allophanatization catalysts especially include zinc compounds, for example zinc(II) stearate, zinc(II) n-octanoate, zinc(II) 2-ethyl-1-hexanoate, zinc(II) naphthenate or zinc(II) acetylacetonate, tin compounds, for example tin(II) n-octanoate, tin(II) 2-ethyl-1-hexanoate, tin(II) laurate, dibutyltin oxide, dibutyltin dichloride, dibutyltin diacetate, dibutyltin dilaurate, dibutyltin dimaleate or dioctyltin diacetate, zirconium compounds, for example zirconium(IV) 2-ethyl-1-hexanoate, zirconium(IV) neodecanoate, zirconium(IV) naphthenate or zirconium(IV) acetylacetonate, aluminum tri(ethylacetoacetate), iron(III) chloride, potassium octoate, compounds of manganese, cobalt or nickel, and also strong acids, for example trifluoroacetic acid, sulfuric acid, hydrogen chloride, hydrogen bromide, phosphoric acid or perchloric acid or any desired mixtures of these catalysts.

Catalysts which are suitable, albeit less preferred, for the process of the invention are also compounds which as well as the allophanatization reaction also catalyze the trimerization of isocyanate groups to form isocyanurate structures. Such catalysts are described for example in EP-A-0 649 866 page 4, line 7 to page 5, line 15.

Preferred catalysts for the process according to the invention are zinc and/or zirconium compounds of the aforementioned type. The use of at least zinc(II) n-octanoate, zinc(II) 2-ethyl-1-hexanoate and/orzinc(II) stearate, zirconium(IV) n-octanoate, zirconium(IV) 2-ethyl-1-hexanoate and/or zirconium(IV) neodecanoate is very particularly preferred.

These catalysts are employed in the process according to the invention, if at all, preferably in an amount of 0.001% to 5% by weight, particularly preferably 0.005% to 1% by weight, based on the total weight of the co-reactants A) and B), and may be added either before reaction commencement or at any time in the reaction.

It is preferable when the process according to the invention does not employ lead octoate as catalyst, with the result that preference is given to a polyisocyanate mixture according to the invention which is free from catalytic amounts, particularly preferably free from detectable amounts, of lead octoate.

The process according to the invention is preferably performed without solvent. However, suitable solvents that are inert toward the reactive groups of the starting components may optionally be co-used. Suitable solvents are, for example, the customary coatings solvents known per se, for example ethyl acetate, butyl acetate, ethylene glycol monomethyl or monoethyl ether acetate, 1-methoxy-2-propyl acetate, 3-methoxy-n-butyl acetate, acetone, 2-butanone, 4-methyl-2-pentanone, cyclohexanone, toluene, xylene, chlorobenzene, white spirit, relatively highly substituted aromatics, such as are commercially available, for example, under the names Solvent naphtha, Solvesso®, Isopar®, Nappar®, Varsol® (ExxonMobil Chemical Central Europe, Cologne, DE) and Shellsol® (Shell Deutschland Oil GmbH, Hamburg, DE), but also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam or any desired mixtures of such solvents.

In one possible embodiment the process according to the invention comprises initially charging the at least PDI-containing starting component A) optionally under inert gas, for example nitrogen, and optionally in the presence of a suitable solvent of the recited type at a temperature between 20° C. and 100° C. Subsequently, the alcoholic component B) is added in the abovementioned amount and the reaction temperature for the urethanization is optionally adjusted via a suitable measure (heating or cooling) to a temperature of 30° C. to 120° C., preferably of 50° C. to 100° C. After the urethanization reaction, i.e. when the NCO content theoretically corresponding to complete conversion of isocyanate groups and hydroxyl groups has been achieved, the allophanatization may be commenced, for example without addition of a catalyst, by heating the reaction mixture to a temperature of 140° C. to 200° C. However, it is preferable to employ suitable catalysts of the aforementioned type to accelerate the allophanatization reaction, wherein temperatures in the range from 60° C. to 140° C., preferably 80° C. to 120° C., are generally adequate depending on the type and amount of the employed catalyst.

In a further possible embodiment of the process according to the invention the catalyst for optional co-use is already admixed either with the at least PDI-containing starting component A) and/or with the alcoholic component B) before commencement of the actual reaction. In this case the urethane groups formed as intermediates undergo spontaneous further reaction to afford the desired allophanate structure. In this type of single-stage reaction mode the starting component A) optionally containing the catalyst is initially charged optionally under inert gas, for example nitrogen, and optionally in the presence of a suitable solvent of the recited type generally at temperatures optimal for the allophanatization in the range from 60° C. to 140° C., preferably 80° C. to 120° C., and reacted with the alcoholic component B) optionally containing the catalyst.

However, it is alternatively possible to add the catalyst to the reaction mixture at any desired time during the urethanization reaction. In this embodiment of the process according to the invention a temperature in the range from 30° C. to 120° C., preferably from 50° C. to 100° C., is generally established for the pure urethanization reaction proceeding prior to the catalyst addition. After addition of a suitable catalyst the allophanatization reaction is finally performed at temperatures of generally 60° C. to 140° C., preferably of 80° C. to 120° C.

In the process according to the invention the progress of the reaction may be followed for example by titrimetric determination of the NCO content according to DIN EN ISO 11909:2007-05. The reaction is terminated upon achieving the target NCO content, preferably when the degree of allophanatization (i.e. the percentage proportion, as is calculable from the NCO content, of urethane groups intermediately formed from the hydroxyl groups of component B) that have been converted to allophanate groups) of the reaction mixture is at least 80%, particularly preferably at least 90%, very particularly preferably when the NCO content corresponding to complete allophanatization has been achieved or exceeded. In the case of a purely thermal reaction mode this may be effected for example by cooling the reaction mixture to room temperature. However, in the case of the preferred co-use of an allophanatization catalyst of the recited type the reaction is generally terminated by addition of suitable catalyst poisons, for example acids, such as phosphoric acid, or acid chlorides such as benzoyl chloride or isophthaloyl dichloride.

The reaction mixture is preferably then freed from volatile constituents (excess monomeric diisocyanates, solvents optionally used, and, when no catalyst poison is being used, any active catalyst) by thin-film distillation under a high vacuum, as for example at a pressure below 1.0 mbar, preferably below 0.5 mbar, particularly preferably below 0.2 mbar, under very gentle conditions, as for example at a temperature of 100 to 200° C., preferably of 120 to 180° C.

The obtained distillates which contain not only the unconverted monomeric starting diisocyanates and optionally co-used solvents but optionally also active catalyst if no catalyst poison was used are readily employable for renewed allophanatization in the process according to the invention.

In another embodiment of the process of the invention, the stated volatile constituents are removed from the oligomerization product by extraction with suitable solvents that are inert toward isocyanate groups, examples being aliphatic or cycloaliphatic hydrocarbons such as pentane, hexane, heptane, cyclopentane or cyclohexane.

Irrespective of the type of workup the obtained products of the process according to the invention are clear, practically colorless polyisocyanate mixtures which, in each case based on the solvent-free solid resin, have color numbers of below 100 APHA, preferably of below 80 APHA, particularly preferably of below 60 APHA, and/or an NCO content of 6.0% to 18.0% by weight, preferably 8.0% to 16.0% by weight, particularly preferably 10.0% to 15.0% by weight, and/or a residual monomer content determined by gas chromatography with an internal standard according to DIN EN ISO 10283:2007-11 of less than 0.14% by weight, preferably less than 0.12% by weight and particularly preferably less than 0.10% by weight.

The viscosities of the polyisocyanate mixtures according to the invention measured according to DIN EN ISO 3219:1994-10 at a shear rate of 250 s⁻¹ at 23° C. are preferably less than 500 mPas, particularly preferably less than 400 mPas, very particularly preferably less than 300 mPas.

The polyisocyanate mixtures according to the invention are completely resistant to crystallization and remain completely clear and free from turbidity even after four weeks of storage at 5° C.

In a further preferred embodiment the polyisocyanate mixtures according to the invention have a residual urethane content of less than 20 mol %, preferably less than 15 mol %, and particularly preferably less than 10 mol %, calculated from the integrals of proton-decoupled ¹³C-NMR spectra and based on the sum of the allophanate, urethane, isocyanurate and/or uretdione structures present in the polyisocyanate mixture according to the invention.

In the present case the “polyisocyanate mixture” according to the invention refers to the oligomer mixture resulting from random distribution and the polyisocyanate mixture according to the invention may therefore also be referred to as the polyisocyanate according to the invention. In a further embodiment the invention thus relates to a polyisocyanate of general formula (I)

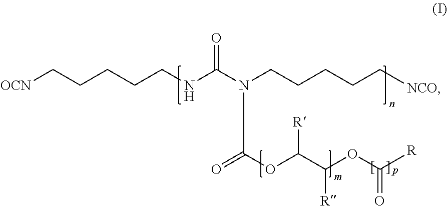

in which
R represents a linear or branched, saturated or unsaturated aliphatic and/or saturated or unsaturated cycloaliphatic radical having (6 to 22)-p carbon atoms which may optionally be substituted,
R′ and R″ independently represent hydrogen or an aliphatic radical having 1 to 10 carbon atoms, wherein at least one of the radicals R′ and R″ represents hydrogen,
n is an integer from 1 to 12,
m is an integer from 1 to 10 and
p is 0 or 1.

In a further embodiment the invention relates to a process for producing a polyisocyanate, preferably the polyisocyanate according to the invention, by reacting
A) a diisocyanate component containing at least 1,5-diisocyanatopentane with
B) at least one alcohol of general formula (II)

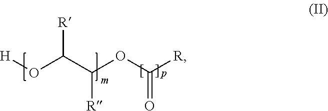

in which
R represents a linear or branched, saturated or unsaturated aliphatic and/or saturated or unsaturated cycloaliphatic radical having (6 to 22)-p carbon atoms which may in each case optionally be substituted,
R′ and R″ independently represent hydrogen or an aliphatic radical having 1 to 10 carbon atoms, wherein at least one of the radicals R′ and R″ represents hydrogen,
m is an integer from 1 to 10 and
p is 0 or 1.

The same preferred embodiments as in the other subjects of the invention apply in the two aforementioned embodiments.

Since the polyisocyanate mixtures according to the invention predominantly comprise allophanate structures as structural elements they may synonymously also be described as allophanate polyisocyanates according to the invention or as PDI-based allophanate polyisocyanates according to the invention. The polyisocyanate mixtures according to the invention represent valuable starting materials for production of polyurethane plastics by the isocyanate polyaddition process. The invention therefore further provides for the use of the polyisocyanate mixture according to the invention as a starting component in the production of polyurethane plastics.

The polyisocyanate mixtures according to the invention are exceptionally suitable as hardeners for two-component polyurethane coatings in which the customary polyether polyols, polyester polyols, polycarbonate polyols and/or polyacrylate polyols are present as the hydroxy-functional component as co-reactants for the polyisocyanates. Preferred hydroxy-functional components are polyacrylate polyols, i.e., polymers or copolymers of alkyl (meth)acrylates, optionally with styrene or other copolymerizable olefinically unsaturated monomers.

They may be employed both as a sole crosslinker component or, due to their low viscosity, particularly advantageously also as reactive diluents for higher-viscosity polyisocyanates, especially those having a uretdione, isocyanurate, iminooxadiazinedione, urethane, allophanate, biuret and/or oxadiazinetrione structure, which bear aliphatically, cycloaliphatically, araliphatically and/or aromatically bonded isocyanate groups, preferably those based on PDI. The present invention further provides for the use of the polyisocyanate mixture according to the invention for diluting relatively high viscosity polyisocyanates, preferably relatively high viscosity polyisocyanates based on 1,5-diisocyanatopentane, while simultaneously maintaining reactivity.

The invention likewise provides for the use of the polyisocyanate mixture according to the invention for blending with polyisocyanates having a uretdione, isocyanurate, iminooxadiazinedione, urethane, allophanate, biuret and/or oxadiazinetrione structure which bear aliphatically, cycloaliphatically, araliphatically and/or aromatically bonded isocyanate groups, preferably those based on 1,5-diisocyanatopentane. This has the advantage that processability is further improved while simultaneously allowing for substitution of fossil raw materials. The invention likewise provides for the aforementioned blends of the polyisocyanate mixture according to the invention and polyisocyanates having a uretdione, isocyanurate, iminooxadiazinedione, urethane, allophanate, biuret and/or oxadiazinetrione structure which bear aliphatically, cycloaliphatically, araliphatically and/or aromatically bonded isocyanate groups, preferably those based on 1,5-diisocyanatopentane.

Although the allophanate polyisocyanates according to the invention/polyisocyanate mixtures according to the invention may be employed without solvent due to their low viscosity, they may, if required, also be diluted with customary solvents, for example the aforementioned solvents inert towards isocyanates for optional co-use in the process according to the invention, without turbidification. In general, the coating compositions formulated with the polyisocyanates according to the invention, into which compositions, optionally, the auxiliaries and additives customary in the coatings sector may be incorporated, for example flow control assistants, color pigments, fillers or matting agents, have good coating properties even in the case of room-temperature drying. However, they may of course also be dried under forced conditions at elevated temperature or by baking at temperatures up to 260° C.

To control the curing rate suitable catalysts may be co-used during formulation of the coating composition, for example the catalysts customary in isocyanate chemistry, for example tertiary amines such as triethylamine, pyridine, methylpyridine, benzyldimethylamine, N,N-endoethylenepiperazine, N-methylpiperidine, pentamethyldiethylenetriamine, N,N-dimethylaminocyclohexane, N,N′-dimethylpiperazine or metal salts such as iron(III) chloride, zinc chloride, zinc 2-ethylcaproate, tin(II) octanoate, tin(II) ethylcaproate, dibutyltin(IV) dilaurate, bismuth(III) 2-ethylhexanoate, bismuth(III) octoate or molybdenum glycolate.

The allophanate polyisocyanates according to the invention are also suitable as crosslinker components for binders or binder components which are dissolved or dispersed in water and have groups that are reactive toward isocyanate groups, in particular alcoholic hydroxyl groups, in the production of aqueous two-component polyurethane systems. Due to their low viscosity they may be used either as such, i.e., in hydrophobic form, or else in a form hydrophilically modified by known methods, for example according to EP-B 0 540 985, EP-B 0 959 087 or EP-B 1 287 052.

The allophanate polyisocyanates according to the invention may also be combined with polyamines, for example the polyaspartic acid derivatives known from EP-B 0 403 921 produced by reaction of diamines with fumaric or maleic esters, or else with polyamines whose amino groups are in blocked form, for example polyketimines, polyaldimines or oxazolanes. The effect of moisture on these blocked amino groups is to turn them into free amino groups and, in the case of the oxazolanes, also into free hydroxyl groups which react with the isocyanate groups of the polyisocyanates according to the invention during crosslinking.

The allophanate polyisocyanates according to the invention may also be combined with compounds comprising at least one thiol group.

These include for example the polythiols known from EP-A 3 872 108, for example simple alkanethiols, thioether groups containing polythiols, polyether thiols, polyester thiols, aromatic thiocompounds and/or mercapto alcohols.

In a preferred embodiment the isocyanate groups of the allophanate polyisocyanates according to the invention may be partly or completely reacted with at least one blocking agent.

These blocking agents are especially the blocking agents known per se from polyurethane chemistry, for example diethyl malonate, ethyl acetoacetate, activated cyclic ketones, such as cyclopentanone-2-carboxymethyl ester and -carboxyethyl ester, acetone oxime, butanone oxime, ε-caprolactam, 3,5-dimethylpyrazole, 1,2,4-triazole, dimethyl-1,2,4-triazole, imidazole, diisopropylamine, benzyl-tert-butylamine or any desired mixtures of these blocking agents.

In blocked form the polyisocyanates according to the invention are also employable in combination with the aforementioned coating binders or coating binder components in the context of one-component PUR baking systems.

In all coating combinations the polyisocyanates according to the invention and the co-reactants are present in amounts such that there are 0.5 to 3, preferably 0.6 to 2.0, particularly preferably 0.8 to 1.6, optionally blocked isocyanate-reactive groups for each optionally blocked isocyanate group. However, the allophanate polyisocyanates according to the invention may optionally be admixed in subordinate amounts with nonfunctional coating binders to achieve very specific properties, for example as an additive to improve adhesion.

Substrates contemplated for the coatings formulated using the polyisocyanates according to the invention include any desired substrates, for example, metal, wood, glass, stone, ceramic materials, concrete, rigid and flexible plastics, textiles, leather, and paper, which prior to coating may optionally also be provided with customary primers.

The invention thus further provides coating compositions containing the allophanate polyisocyanates according to the invention and a substrate which is at least partially coated with a polyurethane, polyurea and/or polythiourethane according to the invention and/or at least one polyisocyanate mixture according to the invention and/or at least one coating composition according to the invention.

The coating compositions according to the invention may be in the form, for example, of a two-component system comprising a crosslinker component containing at least one polyisocyanate mixture according to the invention and a binder component containing at least one coating binder or a coating binder component having groups that are reactive toward isocyanate groups, or in the form of a one-component system containing at least one polyisocyanate mixture according to the invention present in blocked form. Such systems likewise form part of the subject matter of the present invention.

In addition to the preferred use as crosslinker components for solvent-free, solvent-containing or aqueous 2K PUR coatings the polyisocyanates according to the invention are exceptionally suitable as crosslinkers for solvent-free or solvent-containing adhesive binders or aqueous dispersion adhesives or else as synthesis components for production of lightfast compact or foamed polyurethane shaped articles.

The invention thus further provides polyurethanes, polyurea and/or polythiourethanes obtainable or produced by reaction of at least one polyisocyanate mixture according to the invention with at least one hydroxy-, amino- and/or thiofunctional component.

The features specified as preferred for the process according to the invention or the polyisocyanate mixture according to the invention are also preferred for the further subjects of the invention.

The examples which follow serve to illustrate the present invention, but should in no way be understood as imposing any restriction on the scope of protection.

### EXAMPLES

All percentages are based on weight unless otherwise stated.

NCO contents were determined by titrimetry according to DIN EN ISO 11909:2007-05.

All viscosity measurements were taken using a Physica MCR 51 rheometer from Anton Paar Germany GmbH (DE) to DIN EN ISO 3219:1994-10 at a shear rate of 250 s⁻¹.

The residual monomer contents were measured in accordance with DIN EN ISO 10283:2007-11 by gas chromatography with an internal standard.

The contents of sodium and potassium cations were determined by inductively coupled plasma atomic emission spectrometry (ICP-OES) according to DIN EN ISO 11885:2009-09 after microwave digestion. The limit of detection with this method is <1 ppm.

The platinum-cobalt colour index was measured spectrophotometrically in accordance with DIN EN ISO 6271-2:2005-03 using a Lico 400 spectrophotometer from Lange, Germany.

The contents (mol %) of the allophanate, urethane and optionally isocyanurate and/or uretdione structures present in the polyisocyanates according to the invention were calculated from the integrals of proton-decoupled ¹³C-NMR spectra (recorded on a Bruker DPX-400 instrument) and are each based on the sum total of allophanate, urethane, isocyanurate and/or uretdione structures present. In the case of PDI and HDI polyisocyanates dissolved in CDCl₃ the individual structural elements have the following chemical shifts (in ppm): Allophanate: 155.7 and 153.8; urethane: 156.3; isocyanurate: 148.4; uretdione: 157.1.

### Example 1 (Inventive)

At a temperature of 80° C. under dry nitrogen 1234 g (8.0 mol) of pentamethylenediisocyanate (PDI) was admixed with 341 g (1.0 mol) of a lauryl alcohol ethoxylated four times on average (OH number: 164.4 mg KOH/g, Na content: 34 mg/kg, K content: <1 mg/kg) and stirred for 3 hours until an NCO content of 40.0% corresponding to complete urethanization had been achieved. The reaction mixture was then heated to 95° C. and 0.16 g of zinc(II) 2-ethyl-1-hexanoate were added as allophanatization catalyst. Onset of the exothermic reaction caused the temperature of the mixture to increase to 106° C. The exothermicity subsided again after a reaction time of about 30 min. The NCO content of the reaction mixture was 37.1%. The catalyst was deactivated by addition of 0.16 g of orthophosphoric acid and the unconverted monomeric PDI was separated in a thin-film evaporator at a temperature of 130° C. and a pressure of 0.1 mbar. This afforded 679 g of a virtually colorless, clear allophanate polyisocyanate having the following characteristics:

| NCO content: | 12.6% | | |
|---|---|---|---|
| Monomeric PDI: | 0.04% | | |
| Viscosity (23° C.): | 175 mPas | | |
| Color number (APHA): | 15 Hazen | | |
| Composition: | Allophanate: | 82.6 | mol % |
| | Urethane: | 9.4 | mol % |
| | Isocyanurate: | 7.6 | mol % |
| | Uretdione: | 0.4 | mol % |

### Example 2 (Inventive)

1234 g (8.0 mol) of PDI were initially charged under dry nitrogen with stirring at a temperature of 95° C. and admixed with 0.16 g of zinc(II) 2-ethyl-1-hexanoate as catalyst. Over a period of about 45 minutes 341 g (1.0 mol) of the lauryl alcohol ethoxylated four times on average employed in example 1 was added dropwise, onset of the exothermic reaction causing the temperature of the mixture to increase to 100° C. The reaction mixture was subjected to further stirring at 100° C. until after about 1 h the NCO content had dropped to 37.2%. The catalyst was deactivated by addition of 0.16 g of orthophosphoric acid and the unconverted monomeric PDI was separated in a thin-film evaporator at a temperature of 130° C. and a pressure of 0.1 mbar. This afforded 666 g of a virtually colorless, clear polyisocyanate mixture having the following characteristics and composition:

| NCO content: | 12.4% | | |
|---|---|---|---|
| Monomeric PDI: | 0.03% | | |
| Viscosity (23° C.): | 164 mPas | | |
| Color number (APHA): | 21 Hazen | | |
| Composition: | Allophanate: | 83.0 | mol % |
| | Urethane: | 9.1 | mol % |
| | Isocyanurate: | 7.5 | mol % |
| | Uretdione: | 0.4 | mol % |

### Example 3 (Comparative)

1344 g (8.0 mol) of hexamethylene diisocyanate (HDI) were admixed under dry nitrogen at a temperature of 80° C. with 341 g (1.0 mol) of the lauryl alcohol ethoxylated four times on average employed in example 1 and stirred for 3 hours until an NCO content of 37.4% corresponding to complete urethanization had been achieved. The reaction mixture was then heated to 95° C. and 0.17 g of zinc(II) 2-ethyl-1-hexanoate were added as allophanatization catalyst. Onset of the exothermic reaction caused the temperature of the mixture to increase to 104° C. The exothermicity subsided again after a reaction time of about 30 min. The NCO content of the reaction mixture was 34.7%. The catalyst was deactivated by addition of 0.17 g of orthophosphoric acid and the unconverted monomeric HDI was separated in a thin-film evaporator at a temperature of 130° C. and a pressure of 0.1 mbar. This afforded 715 g of a virtually colorless allophanate polyisocyanate having the following characteristics:

| NCO content: | 12.3% | | |
|---|---|---|---|
| Monomeric HDI: | 0.01% | | |
| Viscosity (23° C.): | 148 mPas | | |
| Color number (APHA): | 25 Hazen | | |
| Composition: | Allophanate: | 83.3 | mol % |
| | Urethane: | 9.5 | mol % |
| | Isocyanurate: | 6.6 | mol % |
| | Uretdione: | 0.6 | mol % |

The inventive PDI allophanate polyisocyanates from examples 1 and 2 and the HDI-based comparative polyisocyanate were stored at room temperature for 4 weeks. While the PDI polyisocyanates remained completely clear the HDI polyisocyanate exhibited visible turbidification after only one day. A distinct sediment had formed after 4 weeks. The comparison shows the distinctly improved crystallization stability of the PDI products relative to the comparably synthesized HDI derivative.

### Example 4 (Inventive)

987 g (6.4 mol) of PDI together with 267 g (1.6 mol) of HDI were initially charged under dry nitrogen with stirring at a temperature of 80° C. and admixed with 0.16 g of zinc(II) 2-ethyl-1-hexanoate as catalyst. Over a period of about 30 minutes 341 g (1.0 mol) of the lauryl alcohol ethoxylated four times on average employed in example 1 was added dropwise, onset of the exothermic reaction causing the temperature of the mixture to increase to 102° C. The reaction mixture was subjected to further stirring at 100° C. until after about 1.5 h the NCO content had dropped to 36.1%. The catalyst was deactivated by addition of 0.16 g of orthophosphoric acid and the unconverted monomeric diisocyanates were separated in a thin-film evaporator at a temperature of 130° C. and a pressure of 0.1 mbar. This afforded 677 g of a virtually colorless, clear polyisocyanate mixture having the following characteristics and composition:

| NCO content: | 13.5% | | |
|---|---|---|---|
| Monomeric PDI: | 0.01% | | |
| Monomeric HDI: | 0.01% | | |
| Viscosity (23° C.): | 245 mPas | | |
| Color number (APHA): | 30 Hazen | | |
| Composition: | Allophanate: | 72.7 | mol % |
| | Urethane: | 6.1 | mol % |
| | Isocyanurate: | 20.7 | mol % |
| | Uretdione: | 0.5 | mol % |

### Example 5 (Inventive)

1234 g (8.0 mol) of PDI was initially charged under dry nitrogen with stirring at a temperature of 95° C. and admixed with 0.32 g of zirconium(IV) 2-ethyl-1-hexanoate as catalyst. Over a period of about 45 minutes 341 g (1.0 mol) of the lauryl alcohol ethoxylated four times on average employed in example 1 was added dropwise, onset of the exothermic reaction causing the temperature of the mixture to increase to 107° C. The reaction mixture was subjected to further stirring at 100° C. until after about 1.5 h the NCO content had dropped to 37.1%. The catalyst was deactivated by addition of 0.32 g of orthophosphoric acid and the unconverted monomeric PDI was separated in a thin-film evaporator at a temperature of 130° C. and a pressure of 0.1 mbar. This afforded 658 g of a virtually colorless, clear polyisocyanate mixture having the following characteristics and composition:

| NCO content: | 12.2% | | |
|---|---|---|---|
| Monomeric PDI: | 0.03% | | |
| Viscosity (23° C.): | 150 mPas | | |
| Color number (APHA): | 15 Hazen | | |
| Composition: | Allophanate: | 88.1 | mol % |
| | Urethane: | 6.6 | mol % |
| | Isocyanurate: | 4.8 | mol % |
| | Uretdione: | 0.5 | mol % |

### Examples 6 to 13 (Inventive)

By the process described in example 2, PDI was reacted with lauryl alcohol ethoxylates of different degrees of ethoxylation in different NCO: OH equivalent ratios under zinc octoate catalysis and the resulting mixture worked up by thin-film distillation. The table which follows shows the compositions and characteristics of the reaction batches and of the allophanate polyisocyanates obtained after thin-film distillation.

| Example | | | | | | | |
|---|---|---|---|---|---|---|---|
| 6 | 7 | 8 | 9 | 10 | 11 | 12 | 13 |

Reaction batch

| | | | | | | | | | |
|---|---|---|---|---|---|---|---|---|---|
| Lauryl alcohol | [EO units] | 3 | 3 | 3 | 3 | 3 | 2 | 7 | 7 |
| ethoxylate | | | | | | | | | |
| OH number | [mg KOH/g] | 181.8 | 181.8 | 181.8 | 181.8 | 181.8 | 210.9 | 116.9 | 116.9 |
| Na/K content | [mg/kg] | 28/<1 | 28/<1 | 28/<1 | 28/<1 | 28/<1 | 52/8 | 26/<1 | 26/<1 |
| NCO:OH | [mol] | 20:1 | 16:1 | 16:1 | 16:1 | 20:1 | 16:1 | 16:1 | 16:1 |
| Catalyst content | [ppm] | 100 | 100 | 200 | 200 | 200 | 100 | 100 | 200 |
| Reaction time | [min] | 140 | 170 | 130 | 100 | 130 | 145 | 210 | 115 |
| NCO content of | [%] | 40.0 | 37.0 | 35.6 | 36.3 | 38.6 | 39.0 | 33.1 | 32.5 |
| raw solution | | | | | | | | | |
| Resin yield | [%] | 34.1 | 41.0 | 46.9 | 43.7 | 38.2 | 37.3 | 48.5 | 49.3 |

Product properties

| | | | | | | | | | |
|---|---|---|---|---|---|---|---|---|---|
| NCO content | [%] | 13.0 | 12.9 | 14.2 | 13.9 | 14.7 | 13.7 | 11.0 | 11.3 |
| Monomeric PDI | [%] | 0.02 | 0.02 | 0.03 | 0.03 | 0.03 | 0.03 | 0.03 | 0.04 |
| Viscosity (23° C.) | [mPas] | 130 | 175 | 280 | 230 | 270 | 150 | 230 | 250 |
| Colour number | [Hazen] | 20 | 21 | 24 | 26 | 24 | 21 | 35 | 29 |
| Allophanate | [mol %] | 83.4 | 83.8 | 70.3 | 74.0 | 68.9 | 84.5 | 82.9 | 82.1 |
| Urethane | [mol %] | 8.2 | 8.0 | 4.2 | 6.5 | 7.1 | 7.5 | 9.2 | 9.7 |
| Isocyanurate | [mol %] | 7.7 | 7.5 | 24.9 | 18.4 | 23.3 | 7.3 | 7.4 | 7.6 |
| Uretdione | [mol %] | 0.7 | 0.7 | 0.6 | 1.1 | 0.7 | 0.7 | 0.5 | 0.6 |

1. A polyisocyanate mixture comprising at least one polyisocyanate of general formula (I) 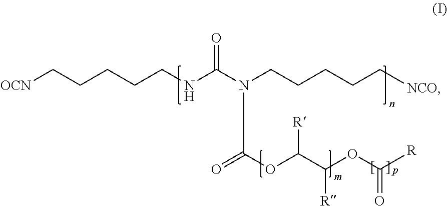
in which
R represents a linear or branched, saturated or unsaturated aliphatic and/or saturated or unsaturated cycloaliphatic radical having (6 to 22)-p carbon atoms which may in each case optionally be substituted,
R′ and R″ independently represent hydrogen or an aliphatic radical having 1 to 10 carbon atoms, wherein at least one of the radicals R′ and R″ represents hydrogen,
n is an integer from 1 to 12,
m is an integer from 1 to 10 and
p is 0 or 1.

2. The polyisocyanate mixture of claim 1 having an NCO content of 6.0% to 18.0% by weight, preferably 8.0% to 16.0% by weight, particularly preferably 10.0% to 15.0% by weight, based on the total weight of the polyisocyanate mixture and/or a residual monomer content measured by gas chromatography using an internal standard according to DIN EN ISO 10283:2007-11 of less than 0.14% by weight, based on the total weight of the polyisocyanate mixture.

3. The polyisocyanate mixture of claim 1 having a viscosity measured according to DIN EN ISO 3219:1994-10 at a shear rate of 250 s⁻¹ at 23° C. of less than 500 mPas.

4. A process for producing a polyisocyanate mixture of claim 1, comprises reacting
A) a diisocyanate component containing at least 1,5-diisocyanatopentane with
B) at least one alcohol of general formula (II) 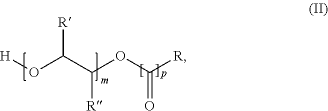
in which
R represents a linear or branched, saturated or unsaturated aliphatic and/or saturated or unsaturated cycloaliphatic radical having (6 to 22)-p carbon atoms which may in each case optionally be substituted,
R′ and R″ independently represent hydrogen or an aliphatic radical having 1 to 10 carbon atoms, wherein at least one of the radicals R′ and R″ represents hydrogen,
n is an integer from 1 to 12,
m is an integer from 1 to 10 and
p represents 0 or 1.

5. The process claim 4, wherein 1,5-pentamethylenediisocyanate and optionally further diisocyanates having aliphatically, cycloaliphatically, araliphatically and/or aromatically bonded isocyanate groups are employed as the diisocyanate component A) in an amount of up to 40% by weight based on the diisocyanate component A).

6. The process of claim 4, wherein the alcoholic component B) comprises
alkoxylation products of fatty alcohols of general formula (III) 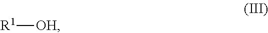
in which
R¹ represents a linear or branched, saturated or unsaturated aliphatic and/or saturated or unsaturated cycloaliphatic radical having 6 to 22 carbon atoms which may in each case optionally be substituted,
and/or alkoxylation products of fatty acids of general formula (IV) 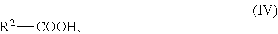
in which
R² represents a linear or branched, saturated or unsaturated aliphatic and/or saturated or unsaturated cycloaliphatic radical having 5 to 21 carbon atoms which may in each case optionally be substituted.

7. The process of claim 4, wherein the alcoholic component B) is alkoxylation products of 1-decanol, 1-dodecanol, 1-tetradecanol, 1-octadecanol, decanoic acid, dodecanoic acid, tetradecanoic acid and/or hexadecanoic acid.

8. The process of claim 4, wherein the alcoholic component B) is selected from alkoxylation products which on average have 1 to 10 alkylene oxide units, wherein the alkylene oxide units comprise of ethylene oxide and/or propylene oxide units.

9. The process of claim 4, comprises reacting the diisocyanate component A) containing at least 1,5-diisocyanatopentane with at least one alcoholic component B) at temperatures of 40° C. to 200° C., while maintaining an equivalent ratio of isocyanate groups to isocyanate-reactive groups of 4:1 to 50:1, to afford allophanate polyisocyanates.

10. The process of claim 4, comprises reacting the diisocyanate component A) containing at least 1,5-diisocyanatopentane with at least one alcoholic component B) in the presence of at least one allophanatization catalyst.

11. A polyurethane plastic produced from polyisocyanate mixture of claim 1.

12. The polyisocyanate mixture of claim 1 further comprising polyisocyanates having a uretdione, isocyanurate, iminooxadiazinedione, urethane, allophanate, biuret and/or oxadiazinetrione structure which bear aliphatically, cycloaliphatically, araliphatically and/or aromatically bonded isocyanate groups, preferably those based on 1,5-diisocyanatopentane.

13. The polyisocyanate mixture of claim 1 further comprising a polyisocyanate based on 1,5-diisocyanatopentane.

14. A polyurethane, polyurea or polythiourethane reaction product produced from the polyisocyanate mixture of claim 1 with at least one hydroxy-, amino- and/or thiofunctional component.

15. A coating composition comprising the polyisocyanate mixture of claim 1, wherein the polyisocyanate mixture is present in admixture with polyisocyanates having a uretdione, isocyanurate, iminooxadiazinedione, urethane, allophanate, biuret and/or oxadiazinetrione structure which bear aliphatically, cycloaliphatically, araliphatically and/or aromatically bonded isocyanate groups.

16. A substrate which is at least partially coated with the coating composition of claim 15.

17. The process of claim 4, wherein the alcoholic component B) comprises
alkoxylation products of fatty alcohols of general formula (III) 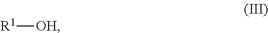
in which
R¹ represents a linear or branched, saturated or unsaturated aliphatic and/or saturated or unsaturated cycloaliphatic radical having 10 to 18 carbon atoms which may in each case optionally be substituted,
and/or alkoxylation products of fatty acids of general formula (IV) 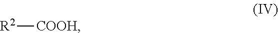
in which
R² represents a linear or branched, saturated or unsaturated aliphatic and/or saturated or unsaturated cycloaliphatic radical having 9 to 17 carbon atoms which may in each case optionally be substituted.

18. The process of claim 4, wherein the alcoholic component B) is selected from alkoxylation products which on average have 2 to 5 alkylene oxide units, wherein the alkylene oxide units comprise of ethylene oxide and/or propylene oxide units.

19. The process of claim 4, comprising reacting the diisocyanate component A) containing at least 1,5-diisocyanatopentane with at least one alcoholic component B) at temperatures of 60° C. to 180° C., while maintaining an equivalent ratio of isocyanate groups to isocyanate-reactive groups of 5:1 to 30:1, to afford allophanate polyisocyanates.

20. The process of claim 4, comprising reacting the diisocyanate component A) containing at least 1,5-diisocyanatopentane with at least one alcoholic component B) in the presence of zinc(II) n-octanoate, zinc(II) 2-ethyl-1-hexanoate, zinc(II) stearate, zirconium(IV) n-octanoate, zirconium(IV) 2-ethyl-1-hexanoate or zirconium(IV) neodecanoate.
